(19) United States
(12) Patent Application Publication
(10) Pub. No.: US 2015/0243133 A1
(43) Pub. Date: Aug. 27, 2015

(54) MOBILE APPLICATION (APP) FOR ELECTRONIC TRANSFER OF FUNDS TO A CASINO PLAYER ACCOUNT FOR WAGERING

(71) Applicant: John J. NICHOLAS, Henderson, NV (US)

(72) Inventor: John J. NICHOLAS, Henderson, NV (US)

(21) Appl. No.: 14/186,552

(22) Filed: Feb. 21, 2014

(51) Int. Cl. G07F 17/32

(52) U.S. Cl. CPC G07F 17/3244

(57) ABSTRACT

A method, apparatus and system are used to provide funds to a player. A PED is provided with an app sending a communication to a funding establishment that supports a financial card. The communication contains data identifying a) a specific financial card and a specific account established at a gaming facility where the gaming apparatus is located and b) amounts of funds to be applied against the financial card and transferred to the specific financial account. The specific financial account electronically transfers funds for available use by the player upon command by the player to the specific financial account. The player profile database is mainly player inputted preferences and gaming trends data stored into each player's profile. These can be accessed/verified with recognition of the player's phone, biometric scan, access card, password, or other terminal kiosk, touch screen, or mobile application.

### BACKGROUND OF THE INVENTION

1. Field of the Invention

The present invention relates to an EFT (Electronic Funds Transfer) for Casino Guests and within the field of wagering, particularly live wagering at a casino, and more particularly to the legal funding of player wagering in real-time at a casino.

2. Background of the Art

Developing and maintaining a loyal customer base is a critical component of operating a successful casino enterprise. To develop a loyal customer base, casino enterprises attempt to generate interactions with their patrons that provide a unique and personalized game playing experience. As an example, casino enterprises offer patrons the opportunity to participate in a loyalty program. Via the loyalty program, patrons are offered various promotions and free items that encourage the patron to return to the casino.

In the loyalty program, the promotions can be tailored to the patron's preferences. As an example, if preferred, a patron can choose to receive promotional credits or earned credits (‘points’) for game play, redemption at any POS (Point of Sale) within the casino, or as play credit on an electronic gaming machine. Information regarding this preference can be stored to an account associated with the loyalty program. In general, information regarding the patron's preferences in regard to promotions as well as other activities within the casino enterprise, such as food, drink and room preferences, can be stored to their account associated with the loyalty program. The patron information stored in the account can be used to personalize the service and the game playing experience provided by the casino enterprise. The deployment of mobile technology such as PlayPal™ adds more data points to the existing business intelligence (BI) and analytics systems to gather and analyze patrons' data and Customer Relationship Management (CRM) of patrons' data used for data-mining to make more informed business decisions. Additionally, a secondary account within the loyalty program is a funded cash account with usable cash value and is tied to the player loyalty accounts. Players can also maintain a balance in their ‘Marker’ account and transfer funds to electronic gaming machines (EGMs), gaming tables and casino facilities through the use of a ‘Marker’ issued by the Casino cage or floor staff. These funds can be attached to their player loyalty cards and have funds immediately available. When funds are depleted in these Marker accounts, casinos require transfer of funds into the accounts to assure that any future withdrawals from the accounts are fully supported. At present, this requires a player to physically appear before the account managing office, provide substantive identification, and transfer funds into the account. This process is inconvenient and time consuming, the result of which is players are removed from active game play, and may then cease wagering.

An ever increasing portion of patrons that visit casinos are regularly carrying portable electronic devices, such as smart phones, laptops, netbooks and tablet computers, on their person. The portable electronic devices provide 1) a means of communication allowing the patron to communicate with other individuals within or outside of a casino via a number of different communication modes, 2) a source of news and information, 3) a portal to the patron's on-line activities, such as social media applications, 4) support for entertainment features, such as audio/video playback and gaming applications, 5) a repository for personal information, such as financial information that enables financial transactions in a mobile wallet applications and 6) a means of capturing information, such as video images and audio recordings. Mobile communications technology is rapidly advancing the exchange of information between users and systems. Thus, portable electronic devices, such as smart phones, are becoming essential tools and in some instances, the primary electronic interface for many individuals.

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. There is a desire among gaming operators for a system that will allow players to remain at machines even when their funds are low or expended.

There are also legal issues to overcome with respect to financing of gaming play. All US Gaming Jurisdictions will not allow direct charges into EGMs or at gaming tables. For this reason, there are Automated Teller Machines (ATMs) in casinos where players can use the credit card cash advance or debit cards to obtain cash. As the machines cannot be directly tied to gaming, only cash is available at ATM locations and at the cash cage. Gaming kiosks are mainstays within casinos and can include one or more of the following: loyalty points amount verification, Loyalty Club promotions, ATM cash withdrawal, credit card cash advance, and point-of-sale (POS) debit cash advance. Similar to ATMs, the gaming kiosks function to allow for cash withdrawals from banking institutions within set limits and also allow for the cashing out of printed cash vouchers generated by the EGM to the players at ‘cash out’ point of play. Use of ATMs and gaming kiosks require a player to leave his gaming location and/or solicit other players or gaming employees to ‘watch’ and save a position at the machine while funds are accessed at another location. The ATMs and gaming kiosks usually have strict limits on the amounts of cash that can be dispensed at any time, many times limited by state gaming statute.

It is desirable for the casinos and the players to develop a funding mechanism for the players that can be exercised in a short period of time and does not require the player to leave what may be a preferred gaming station. Accordingly, there exists a demand for improved customer service capability in the mobile wireless regime that allows for transfer of funds and enhancing the capability of the player to interact with account information.

Not only does this mobile app bring the gaming industry in pace with current technology, it also may assist in reducing long lines at the Players' Club, kiosks, and cage as well as improving operational efficiency, and may reduce cash reserves which must be placed and replenished at the multiple kiosk locations within any casino. Mobile technology also may allow the gaming industry to analyze data previously unavailable, for example GPS locators of players, and provide data for enhanced marketing efforts such as events, shows, special in house promotions, and Casino services and other informed business decisions. PlayPal™ mobile technology provides an easy way for players to check points, comps, and promotions as well as the ability to preload their Loyalty Card with Player Cash or loyalty points, increasing customer satisfaction. Transactions and inquiries can be performed on smart phones while at home and within the Casinos while dining, lounging by the pool or walking through the property.

US Published Patent Application Document No. 20130203483 (Joshi) describes a virtual currency based online social wagering system and method, based on at least one wagering network server. The system can handle wagers initiated by multiple users using commonly available computerized devices such as smart phones. The system avoids legal problems through the use of virtual currency rather than money (which makes the interactions wager-like events, rather than actual wagers), and facilitates interactions between friends by drawing upon social networks for much of the interactions. The system is also designed to make friendly social interactions such as banter, “trash talk”, or “swagger” a key part of the wagering experience. Various internal controls insure that the virtual funds are managed correctly.

US Published Patent Application Document No. 20110077073 (Gagner) describes a wagering game account management system and its operations. In embodiments, the operations include presenting a graphical user interface that includes a graphical control associated with a credit account belonging to a wagering game player; detecting a selection of the graphical control that initiates a financial transaction to transfer money from the credit account to a wagering game session account; determining access information stored in a player profile, the access information to access the credit account; determining an amount to transfer from the credit account to the wagering game session account balance; determining one or more rules limiting use of the credit account; and enforcing the one or more limitation rules on the use of the credit account.

US Published Patent Document 20140018155 (Nelson) describes a gaming system compatible with patron-controlled portable electronic devices, such as smart phones or tablet computers. When a player surpasses predetermined game play parameters on a game of an EGM, a bonus game or related game material may be “unlocked” and offered to the player for download onto the player's Portable Electronic Device (PED). Upon installation, the game or content may be viewed or played on their PED at a later time and at their leisure.

US Published Patent Document 20110040655 (Hendrickson) describes a real time management system for marketing to customers and vendors with customer purchasing and preference data in specific consumer markets including restaurant, retail, travel, hospitality, entertainment, and combinations thereof. The management database allows the consumer to make Precision Purchasing™ transactions, reservation transactions, and Precision Gifting™ transactions via a web-based interface, POS based touch screen interface, and mobile device-based interface. The consumer profile database is comprised of mainly consumer inputted preference and consumer purchase data which is stored into each customer profile and can be accessed/verified with a GPS recognition of the customer's phone, biometric hand or finger scan, access card, retinal scan, password, key fob, or other terminal kiosk, touch screen, or mobile application of the like. All data inputted into the Precision Marketing™ system will be stored in each consumer's personal/business account. Only consumer-authorized parties may access the account holder's personal preference information for the purposes of Precision Gifting™ and Precision Purchasing™, but he/she may never access the customer's confidential information. All changes made to each profile and the purchase preference information will be updated in real-time. All reservations, fund transfers, purchases, and other transactions are stored in the central database system and used for the purposes of Precision Marketing™ and Precision Gifting™.

All references cited herein are incorporated by reference in their entirety for technical enabling content with respect to apparatus, software, hardware and methods of communication, security and gaming.

These systems do not achieve the benefits of real time legal transfer of funds into a player account for immediate use by the player at gaming equipment.

### SUMMARY OF THE INVENTION

A method, apparatus and system are used to provide funds to a player at a gaming apparatus. An application (app), which can be downloaded to a PED, and through which is sent a wireless communication to a funding establishment that supports a financial card. This wireless link is to the existing ATM systems, third party financial funding or kiosks already in place, licensed, approved, and overseen by the Gaming Regulations Boards within the licensing states and are also heavily overseen by banking regulations, both local and federal. The links to the financial institutions are pre-determined by the agreements with the cash advance companies. Whatever companies they have agreements with would be accessible through PlayPal™. The wireless communication contains data that identifies 1) a specific financial card and a specific account established at a gaming facility where the gaming apparatus is located and 2) an amount of funds to be applied against the financial card and transferred to the specific financial account. The specific financial account (any financial account that can transfer funds, provide funds, or provide immediate credit) electronically transfers funds to the gaming apparatus only upon the re-activation of the Loyalty Club membership card and an authentication mechanism (e.g., PIN), to transfer any amount the players wishes to use at that session into existing services (ATM account, PayPal™ account, Google Wallet™ account, etc.) that may be accessed to fund the player loyalty account and subsequently be used for game play, for available use by the player upon command by the player to the specific financial account. Any access to funds in these player specific financial and access through the cash providing or fund providing systems (including the ATM) are done through secure transactions with standard or improved security and confidentiality. Passwords, PINs, encryption, biometric identification, and any other security measures may be used.

The present invention relates to a system and method for an additional touch point for casino player analytics to improve the accuracy of marketing to players by compiling a consumer profile database using inputs from web-based, point-of-service-based, and mobile device-based systems that collect data relating to player preferences and purchases. By developing profiles based on consumer preferences and purchases in certain industry sectors and the like, and by using such profiles and purchase information in conjunction with the geographic position of the customer to make recommendations and marketing offers across several industry sectors.

An app (software enabled method application, or software provided on a mobile device to provide a method or communication capability) that communicates identification of a credit card, smart card or debit card to a funding source (e.g., bank, credit union and the like that manages the credit card) which can be downloaded to a PED. A pre-established link to a player loyalty program/wagering account at a casino or other gaming establishment (e.g., race track, card room, off-track betting site, etc.) has been previously established (usually by more substantive security oversight than a single electronic communication, such as by written and personal authorization by a player when registering at a casino or when setting up the underlying loyalty program/wagering account/expense account). The player, through the PED, authorizes transfer of an identified or selected amount of funds, guaranteed by the credit card, into the player account. As this transfer into the casino account through the credit card is not directly applied to a gaming machine or table game or wager, it is believed that the transfer is legal under existing laws. Once the funds are in the account, they are immediately accessible by the player through the loyalty card for use in gaming. The transfer of funds through the PED, using an established line of transfer from the source of funds supporting the credit card, smart card or debit card, is performed in real-time. The funds are considered substantively in the player account upon transfer, the new funds can be available to a player for use in less than a minute and the player will not have to leave his gaming location. The method is similar to the current method wherein the player must exit the preferred gaming station and go to an ATM or kiosk; await his or her turn to access the ATM or kiosk; insert the selected funding card and PIN; and select the amount to be funded. The funds are received in real cash, creating a risk to the player for observation by nefarious individuals which has led to violent activities by others. The present invention eliminates the transfer of hard cash and creates a virtual cash transfer to the player account.

Not only does this mobile app bring the gaming industry in pace with current technology, it also reduces long lines at the Players' Club, kiosks, and cage as well improves operational efficiency, and dramatically reduces the cash reserves which must be placed and replenished at the multiple kiosk locations within any casino. Mobile technology also allows the gaming industry to analyze data previously unavailable, for example GPS locators of players, and provide data for enhanced marketing efforts such as events, shows, special in house promotions, and Casino services and other informed business decisions. PlayPal™ mobile technology provides an easy way for players to check points, comps, and promotions as well as the ability to preload their Loyalty Card with Player Cash or loyalty points, increasing customer satisfaction. Transactions and inquiries can be performed on smart phones while at home and within the Casinos while dining, lounging by the pool or walking through the property.

### BRIEF DESCRIPTION OF THE FIGURES

The present invention is illustrated by way of example and not limitation in the Figures of the accompanying drawings in which:

FIG. 1 is a block diagram illustrating account transactions, according to example embodiments of the invention.

FIG. 2 is a block diagram illustrating a wagering game machine architecture, according to example embodiments of the invention.

FIG. 3 is a block diagram illustrating a wagering game network 300, according to example embodiments of the invention.

FIG. 4 is a flow diagram illustrating operations for facilitating account transactions on a wagering game machine through a user interface, according to example embodiments of the invention.

FIG. 5A is a block diagram illustrating a graphical user interface through which players can request account transactions from a wagering game machine, according to example embodiments of the invention.

FIG. 5B is a block diagram illustrating account information in a wagering game machine's graphical user interface, according to example embodiments of the invention.

FIG. 6 is a flow diagram illustrating operations for processing account transactions made at a wagering game machine, according to example embodiments of the invention.

FIG. 7 is a flow diagram illustrating operations for presenting an account rule interface, according to example embodiments of the invention.

FIG. 8 shows an example of a Use Case Diagram for practice of the present technology.

FIG. 9 shows a Deployment Diagram for a technology practiced within the scope of the present technology.

FIG. 10 shows an Activity Diagram for a technology practiced within the scope of the present technology.

FIG. 11 shows a screen shot of a home screen for a technology practiced within the scope of the present technology.

FIG. 12 is a perspective view of a wagering game machine, according to example embodiments of the invention.

### DETAILED DESCRIPTION OF THE INVENTION

A method, apparatus and system are used to provide funds to a player at a gaming apparatus. What is meant by a gaming apparatus is any electronic gaming machine, electronic multiplayer gaming table, banked array of electronic games, theater distributed electronic wagering input terminals (which are collectively referred to as electronic gaming apparatus) or gaming tables in which pit bosses are in electronic communication with a central server and the player account system so that they may use credit in a player account to provide cash or chips to players at the gaming tables (referred to as electronically funded gaming table apparatus). An app is downloaded to a PED (mobile phone, smart phone, tablet, or the like) through which is sent a wireless communication to a funding establishment that supports a financial account The app may be downloaded at a cost or for free at the casino or casinos may provide PEDs for client use. The app will be implemented by the casino and the credit card guarantor for the credit card(s) used in the app. The wireless communication contains data (which is encrypted and securely stored) that identifies 1) a specific financial account (which may be represented or identified or accessed through a card) and a specific account established at a gaming facility where the gaming apparatus is located and 2) an amount of funds to be applied against the financial account and transferred to the specific player account. The link between the financial guarantor of the financial account may be (or for casino security must be) established in advance of the execution of the transfer of funds through the financial institution and to the player account. The communication is secure and may be encrypted. The specific financial account electronically transfers funds (based on a cash advance to the credit card or other financial card) to the gaming apparatus for available use by the player upon command by the player to the specific financial account.

An app (software enabled method application) that communicates identification of a financial transaction card (e.g., credit card, smart card or debit card) to a funding source such as a financial institution (e.g., bank, credit union and the like that manages the credit card) can be downloaded to a PED. A pre-established link to a player loyalty program/wagering account at a casino or other gaming establishment (e.g., race track, card room, off-track betting site, etc.) has been previously established (usually by more substantive security oversight than a single electronic communication, such as by written and personal authorization by a player when registering at a casino or when setting up the underlying loyalty program/wagering account/expense account). The player, through the PED, authorizes transfer of an identified or selected amount of funds, guaranteed by the financial account, into the player account. As this transfer into the casino account through the credit card is not directly applied to a gaming machine or table game or wager, it is believed that the transfer is legal under existing laws. Once the funds are in the account, they are immediately accessible by the player through the loyalty card for use in gaming. As the transfer of funds through the PED, using an established line of transfer from the source of funds supporting the credit card, smart card or debit card, is performed in real-time, and the funds are considered substantively in the player account upon transfer, the new funds can be available to a player for use in less than a minute and the player will not have to leave his gaming location. The present invention also queries the player as to whether he or she actually wants to transfer funds for gaming at two distinct levels, thus aiding in the ‘Responsible Gaming’ programs within the industry. A casino owning or leasing the technology of the present invention (referred to as PlayPal™ accounting system) may be able to comp or further comp players out of transaction fees brought in from transaction fees applied to PlayPal™ accounting systems.

Various aspects of the present invention may include methods, apparatus and systems. A method of providing funds to a player at a gaming apparatus includes:
a portable electronic device sending a wireless communication to a funding establishment that supports a financial card;
the wireless communication containing data that identifies 1) a specific financial card and a specific account established at a gaming facility where the gaming apparatus is located and 2) an amount of funds to be applied against the financial card and transferred to the specific financial account; and
the specific financial account electronically transferring funds to the gaming apparatus for available use by the player.

The invention may include machine-readable media having instructions stored thereon and methods performed therewith. The instructions, when executed by a set of one or more processors causes the set of one or more processors to perform operations comprising: presenting a graphical user interface on a PED that includes a graphical control associated with a financial card account belonging to a wagering game player and a casino cash account; detecting a selection, via the graphical user interface, of the graphical control that initiates a financial transaction to transfer funds through the financial card account to a casino cash account and then transfer money from the casino cash account to a wagering game session account.

Machine readable media may be stored as an app in a portable electronic device enabling electronic transfer of funds through a credit card arrangement between a financial institution and a specific player financial account. The media directs authorized communication (e.g., a pre-established link, contractual account, etc.) from the portable electronic device that identifies the credit card to be debited by the financial institution for transfer of a specific amount of funds to the specific player financial account at a gaming facility. This last transfer may also be pre-established by a link or contractual arrangement. The specific player gaming account may be associated with an account selected from the group consisting of a casino wagering account, a race track wagering account, and a card room account. The machine readable media may have the specific player account associated with a player loyalty account at a casino, and the media configures the portable electronic device to authorize transfer of accessible funds from the specific player account to a cash or fund (e.g., tickets, vouchers, and the like)providing system. The cash or fund providing system is an automated teller machine or ticket-in-ticket-out apparatus at a casino.

The method may include: initiating, through a mobile app on a PED, an electronic funds transfer of a transaction amount from a financial account to a casino-stored wagering game account, wherein the credit card financial account has an established link to a wagering establishment-based player account; the app enabling authorization for the financial card financial account to transfer funds debited against the financial card financial account into the wagering establishment-based player account; and then said funds from the wagering establishment-based player account are transferred to a gaming apparatus. The financial card is a credit card assured by a financial institution, such as where the financial institution is selected from the group consisting of banks, savings and loans and credit unions.

A method may also have one or more processors determine access information stored in a player profile, the access information to access the financial account; determining an amount to transfer from the financial account to the casino cash account and then transfer a second amount to from the casino cash account to the wagering game session at a gaming apparatus.

In some embodiments, in the electronic gaming apparatus, one or more machine-readable media having instructions stored thereon, which when executed by a set of one or more processors causes the set of one or more processors to perform operations comprises presenting a graphical user interface that includes a graphical control associated with a casino-serviced credit account belonging to a single wagering game player. A PED initiates a financial transaction to transfer money from the specific player credit account (through a financial account) to a player account (e.g., loyalty account, central credit account, etc.). From that player account, funds can be transferred to a wagering game session account at a specific gaming apparatus. The system may determine access information stored in a player profile, the access information to access the credit account; determining an amount to transfer from the specific player credit account to the wagering game session account balance. The system may enable determination of one or more rules limiting use of the credit account and enable enforcing the one or more limitation rules on the use of the specific player credit account. In some embodiments, the one or more limitation rules are restrictions that comprise any one or more of prohibitions on the use of the credit account, transaction amount limits, periodic use limits, and wagering game session limitations. In some embodiments, the operation of enforcing the one or more limitation rules on the use of the credit account comprises determining that the transaction amount exceeds a spending limit for the credit account; and presenting a message, via the graphical user interface, indicating that the transaction amount exceeds the spending limit. In some embodiments, the operation of enforcing the one or more limitation rules on the use of the credit account comprises determining that the transaction amount is within a spending limit for the credit account; and transferring the transaction amount from the credit account to the wagering game session account.

In some embodiments, a method comprises accomplishing from a PED having an embedded app, the initiation of an electronic funds transfer of a transaction amount from a financial account supporting a credit card to a specific player account at a gaming or wagering facility. From the specific player account (e.g., player loyalty account, casino account), funds may then be treated as in a wagering game account. The financial account supporting the financial card has transferred funds to a specific player account at a casino and the specific player financial account funds the wagering game account as at gaming tables or in an electronic gaming machine.

In some embodiments, a system comprises a machine configured to access a wagering game account, the machine including, an account manager configured to present a graphical user interface including menus for creating an account rule, wherein the account rule specifies a financial transaction associated with the wagering game account and a credit account, and wherein the account rule specifies a condition that when satisfied will cause initiation of the financial transaction, an external system interface configured to transmit the account rule, and a wagering game unit configured to present wagering games; and an account controller configured to receive the account rule, initiate the financial transaction upon satisfaction of the condition specified in the account rule, determine one or more limitation rules that can restrict the use of the credit account for wagering games, and process the financial transaction according to the one or more limitation rules.

In some embodiments, an apparatus, comprises means for detecting the initiation of a financial transaction to augment funds in a wagering game account by transferring money from a first credit account to the wagering game account, wherein the first credit account is associated with a player account; means for determining access information stored in the player account, the access information to access the first credit account; means for determining a default transaction amount to transfer from the first credit account to augment funds in the wagering game account; means for determining a funds transfer limit that limits a total amount of money that can be transferred, for wagering game purposes, from the first credit account to the wagering game account during a specified period; and means for limiting the default transaction amount to the funds transfer limit.

This further description is divided into sections. The first section provides an introduction to embodiments of the invention, while the second section describes wagering game machine architectures and wagering game networks. The third section describes interfaces and operations of some embodiments and the fourth section describes example wagering game machines in more detail.

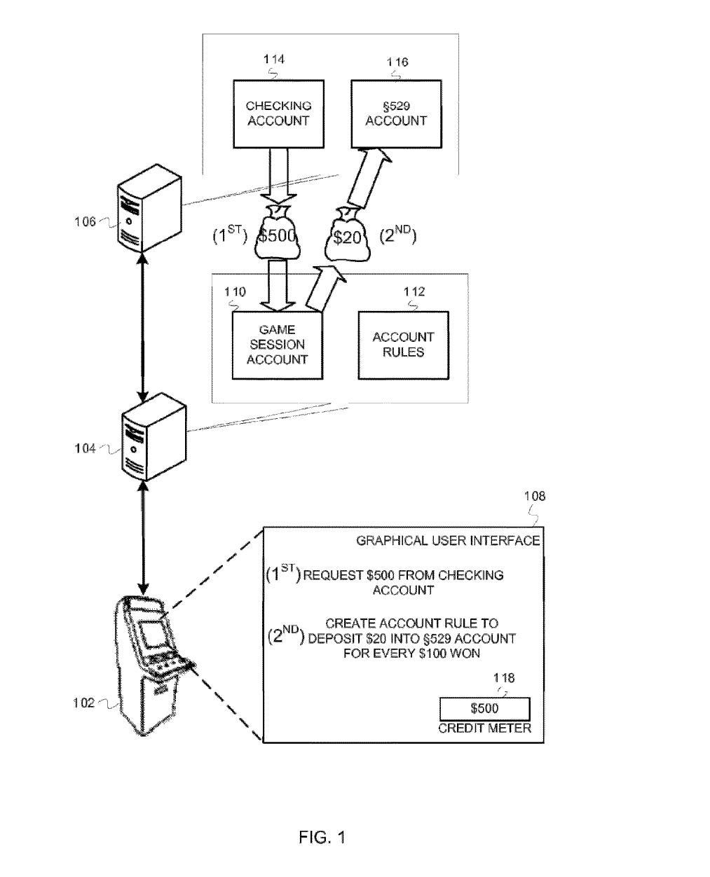

Wagering game machines typically offer a limited number of ways for players to provide monetary value for use in wagering games. Some wagering game machines allow players to insert cash and cashless vouchers or to draw from specific player loyalty accounts or casino gaming accounts. However, wagering game machines typically do not offer many other ways to procure funds. As a result, when players run out of cash, cashless vouchers, and/or casino account funds, they often leave the casino floor to acquire additional funds. For example, players may go to automated teller machines, banks, or other institutions from which they can procure funds. Some embodiments of the invention enable players to acquire funds from a variety of sources through an app on a PED through a financial card without leaving a wagering game machine. Additionally, some embodiments enable players to specify conditions under which various account transactions will take place. The discussion of FIG. 1 describes some of these embodiments in more detail.

EGM-PED Interfaces

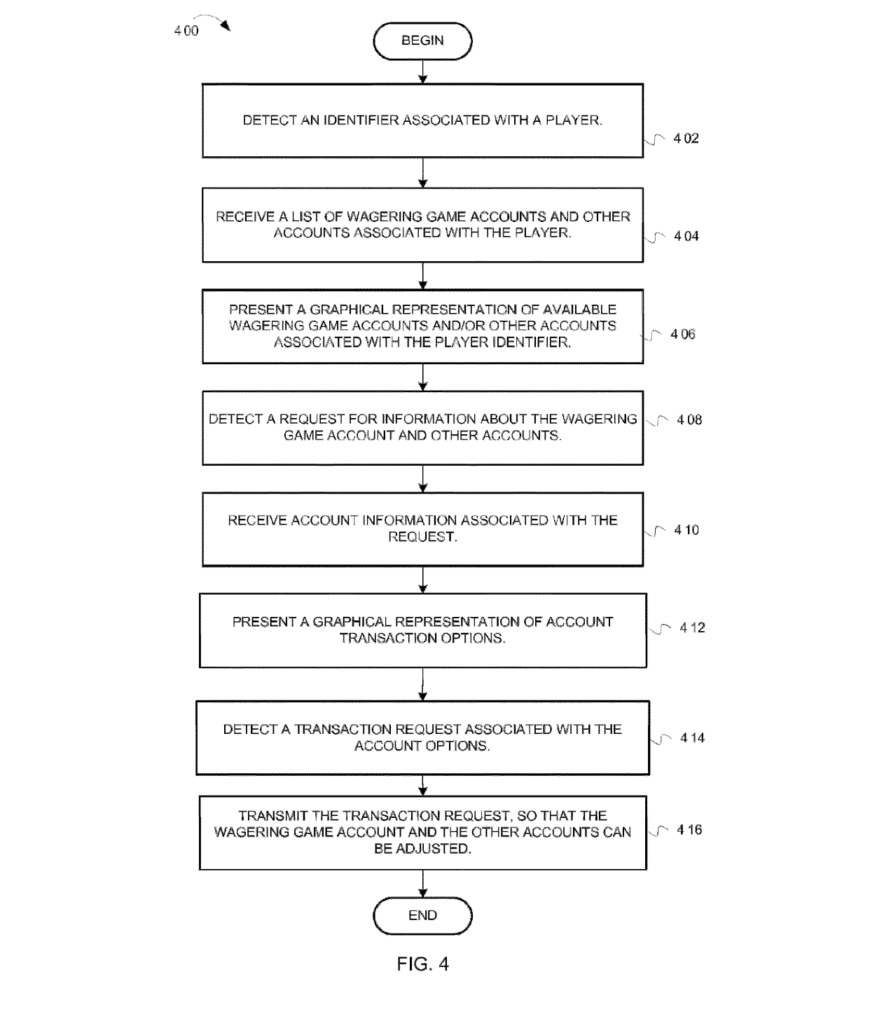

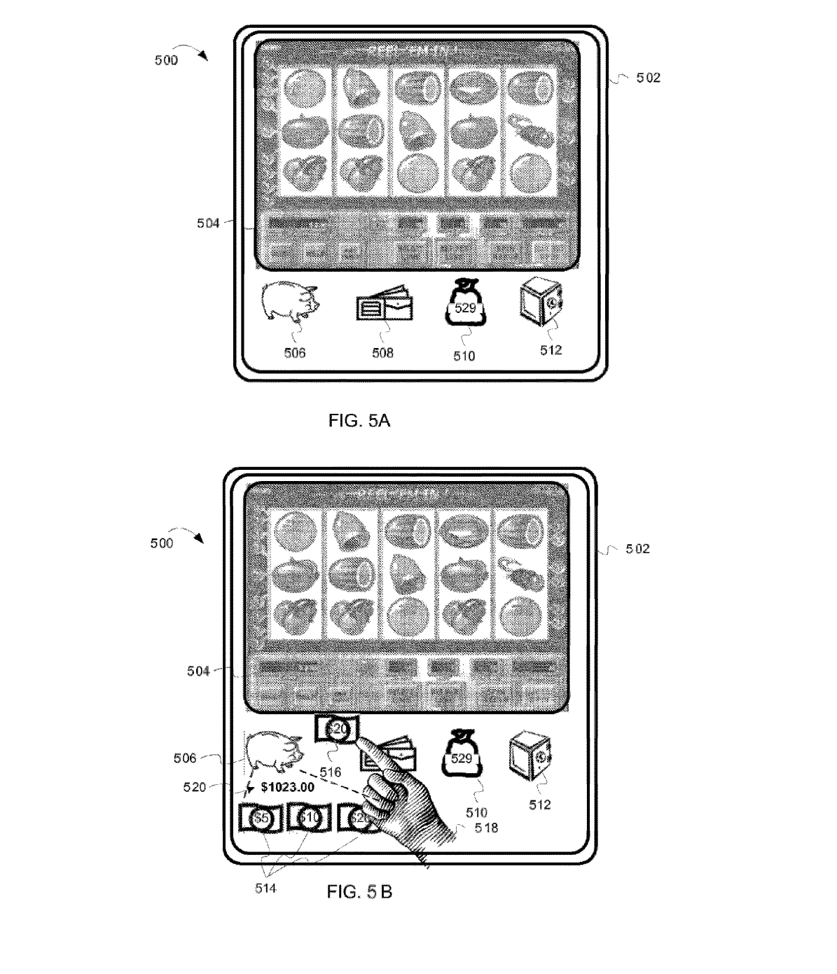

In this section, some examples of interfaces on an EGM that enable PED interactions are described. FIG. 1 shows an EGM 2 with interfaces for interacting with a PED. The EGM 2 can be part of a gaming system that includes a number of gaming devices and servers, such as sever 4. The communication connection 6 between the EGM 2 and the server 4 can be wired, wireless,(e.g., near field communication, Bluetooth™, etc.) or other electronic communication method known, in development or net yet invented or a combination of wired and wireless communication links depending on the local and/or wide area network topology used within the gaming system. The EGM 2 can include a) displays, such as a main display 26 on which a wager-based game can be output, b) audio devices, such as speaker 24 for outputting sounds from the EGM and c) a player input panel 28 including buttons for making inputs associated with the play of the wager-based game, as well as the input of Sensitive Information (SI). These devices can be controlled by a game controller (not shown) located within the cabinet of the EGM 2. Further details of the EGM's game controller and other gaming related methods that can be utilized within the gaming system are described with respect to FIGS. 4 and 5.

The EGM 2 can include a number of different types of interfaces that enable interactions with a mobile or portable electronic device, such as a cell phone, a smartphone, a laptop or a tablet computer. One type of interface is a power interface. Another type of interface, described in more detail below is a communication interface which is the interface utilized in the present invention. Via a power interface, power can be supplied to the PED. For instance, power interfaces 32 and 34 can be configured to receive a connector that allows an electronic device to be electrically coupled to the EGM 2. In one embodiment, the power interface 32 and 34 can be configured to accept a USB connector and thus, can be compatible with USB connector power requirements. Other types of power interfaces, such as a standard 120V receptacle can be provided.

In general, one or more power interfaces can be provided. When two or more power interfaces are provided the interfaces can employ the same or different power configurations. For instance, when two interfaces are provided, both can be configured to accept a USB connector or a first can be configured to be compatible with a USB connector while a second can be compatible with a two pronged connector. Thus, the voltage and current supplied by each power interface can vary from interface to interface depending on the power standard for which the power interface is configured. The one or more power interfaces can be located on different surfaces of the EGM 2. For instance, power interface 32 is located on an upper surface of the player input panel 28 and power interface 34 is located on a front surface of the player input panel 28. In other examples, the power interfaces can be located on a different surface, such as a front surface of the EGM cabinet.

A connector 18 is shown leading from power interface 32 to PED 14 positioned on the player input panel 28 and a connector 20 is shown leading from power interface 20 to a portable device (not shown) located in the pocket 10 of user 8. At the device end, the connector, such as 18 or 20, can include a power interface compatible with the portable device, such as device 14 or the device located in the pocket of user 8. At the EGM end, the connector, such as 18 or 20, can include a power interface compatible with the EGM power interface. The interfaces at each end of the connector can be coupled via a cord. Typically, the interface between a connector (e.g., 18 or 20) and a portable device varies widely from model to model and from manufacturer to manufacturer where the interface at the device end can transmit communications and/or power to the portable device. Thus, in one embodiment, the connector, such as 18 and 20, can be provided by the user, such as 8.

In yet another embodiment, an interface 30 for wireless power transmission can be provided on the EGM 2. As an example, player input panel 28 includes a wireless power interface 30, such as a Powermat™ (Powermat Inc, Commerce Charter Township, Mich.). The wireless power interface can be compatible with a number of different types of devices. A portable device 16 is shown resting on the wireless power interface in a position that allows it to receive power via the wireless power interface 30. Power to the wireless power interface can be switched on and off depending on the machine status.

In particular embodiments, the interfaces 30, 32 and 34 can include sealing mechanisms that are configured to protect the interface in the case of spill, such as a user spilling a drink on the interface. Further, the interfaces can be configured to protect against electrostatic discharge (ESD). The ESD protection can include isolation circuits, filtering circuits, and suppression components, such as multilayer varistors, silicon diodes, and polymer-based suppressors. Suppression components protect the circuit by clamping the ESD voltage to a level that the circuit can survive. Connected in parallel with the signal lines, the suppressors clamp the ESD voltage and shunt the majority of the ESD current away from the data line, and the protected chip, to the appropriate reference. Typical references are the power rail and chassis ground.

In alternate embodiments, one or more of the interfaces 30, 32 and 34, can be configured as power and data interfaces or as a data only interface. For instance, via interface 32 and connector 18, power and data can be transmitted from the EGM 2 to the PED 14 or only data can be transmitted between the EGM 2 and the PED 14. In one embodiment, for security purposes, when a data interface is provided, the communications can be unidirectional such that only data can be sent from the EGM 2 to the portable device via the data interface. In other embodiments, the return communications that can be sent from the device to the EGM 2 and recognized by the game controller can be very limited for security purposes. The format of the return communications can be described by a communication protocol (and/or implemented with an application program interface).

The EGM 2 can support one or more wireless communication interfaces for communicating with a PED, such as 14 or 16. For instance, a first communication wireless interface can support Bluetooth™ communications, a second wireless communication interface can support communications via Wi-Fi™ (compatible with IEEE 802.11 standards) and a third wireless communication interface can support a NFC communication protocol (see FIG. 4 for more detail). By communicating through the EGM, better security for the casino can be maintained to assure that legal transactions are occurring and that the individual communicating with the financial card service and provider is the appropriately authorized individual. In one embodiment, a wireless communication interface can be integrated or located proximate to the wireless power interface. For example, a wireless communication interface supporting an NFC (near field communication) communication protocol can be integrated with the wireless power interface 30. Thus, when the device 16 is placed near the wireless communication interface 30, NFC formatted communication can occur between the device 16 and the EGM 2. In other embodiments, the wireless communication interfaces can be placed in other locations within the EGM 2. Thus, the placement near the wireless power interface is discussed for the purposes of illustration only.

In one embodiment, the NFC communication can be used to exchange information to allow a secure pairing to be established between a user-controlled device and the EGM 2. For instance, Bluetooth™ pairing occurs when two Bluetooth devices agree to communicate with each other and establish a connection. In order to pair two Bluetooth wireless devices, a password (passkey) is exchanged between the two devices. The Passkey is a code shared by both Bluetooth devices, which proves that both users have agreed to pair with each other. After the passkey code is exchanged, an encrypted communication can be set up between the pair devices. In Wi-Fi paring, every pairing can be set up with WPA2 encryption or another type of encryption scheme to keep the transfer private. Wi-Fi Direct is an example of a protocol that can be used to establish point-to-point communications between two Wi-Fi devices. The protocol allows for a Wi-Fi device pair directly with another without having to first join a local network. The method makes it possible to share media from a phone, play multiplayer games or otherwise communicate directly, even when no router exists. Via pairing between the EGM 2 and portable electronic device, a portable electronic device may be able to utilize some of the functionality of secondary devices residing on the EGM 2. For instance, it may be possible for a player to print something from their portable electronic device using the printer on the EGM 2 when it is paired to the EGM 2.

The EGM 2 can include one or more support structures configured to receive a portable electronic device. The support structures can be integrated into the EGM cabinet such that a device placed in the support structure isn't easily knocked out of the support structure and placement of the device doesn't block access to input buttons on the EGM 2 during game play. The support structure can be configured to support a device various positions, such as upright, on its side or on its back. Further, the support structures can be configured to allow a device received in the support structure to be positioned in a preferred orientation. For instance, device 14 is placed in a support structure with a receptacle built into the player input panel 28 that allows the device to be orientated in an upright position. As another example, device 16 is placed flat on a ledge of the player input panel 28. The ledge can include an indentation or a high-friction material (anti-slip) that is designed to keep the device 16 from sliding off of the ledge. Support structures can be placed in other locations on the EGM cabinet and these examples are provided for the purposes of illustration only.

The support structure can include a stand or bracket for supporting the device. In alternate embodiments, the support structure, data interfaces and power interfaces can be incorporated into a secondary device utilized on the EGM 2. For instance, one or more of a support structure, a power interface or a wireless interface can be incorporated into a player tracking unit with a smart interface board (SMIB), a card reader, a bill validator or a printer. Further, all or a portion of the control of the power interfaces and/or wireless interface in the manner described herein can be performed by a secondary processor on the secondary device in conjunction with or independently of the game controller on the EGM 2. In another embodiment, all or a portion of the control of the power interfaces and/or wireless can be implemented in a “service window” type architecture.

Feedback mechanisms can be utilized to indicate a status of an interface. For instance, audio devices can be used to provide audio feedback and/or vibration generating devices, which can also produce an audible buzz, can be used to provide feedback. These feedback mechanisms can be used alone or in combination with other feedback mechanisms, such as a light generating mechanism, to indicate the status of various processes implemented on the EGM 2.

When a PED is detected near the EGM 2, the game controller can be configured, after certain game events, to notify a player to retrieve and/or disconnect their device from the EGM 2. For instance, after a cashout command is received by the game controller, the gaming controller can be configured to display a message 38, such as “Don't forget your Mobile Device.” As another example, the EGM 2 can be configured to emit a sound effect, such as a beeping to get the user's attention in regards to retrieving a device. In yet another example, the EGM 2 configured to flash lights in a distinctive pattern to get the user's attention.

EGM-PED-User Interactions

To start game play, credits are first deposited on the EGM 2 that can be used for wagers. For instance, currency or a ticket voucher redeemable for credits can be inserted in bill acceptor 35, or credit transfer from the player specific casino cash account to the gaming apparatus. The ticket voucher can be validated by a remote server in the gaming system, such as 4. As another example, information can be transferred from the PEDs, 14 or 16, to the EGM 2 according to the technology enabled herein. The EGM 2 can include wireless and/or wired interfaces that enable communications between the EGM 2 and the PEDs to be established.

The PEDs, such as 14 or 16, can be configured as an electronic wallet and the information transfer can be used to initiate an electronic funds transfer according to the presently enabled technology that results in credits being deposited on the EGM 2. The use of the PED in for these transactions can alert the EGM 2 to the presence of the PED. In response to the use of PEDs for these purposes, the EGM 2 may attempt to initiate communications with the PED that allow it to use the PED's wide area network access capabilities.

Whether credits are deposited via a tangible medium, such as a ticket voucher or paper currency, or electronically, such as through the player program at the casino/wagering establishment or via the PED, the user is likely to be near the front of the EGM 2. Thus, if they are carrying a PED, it is likely to be in the general area of the EGM 2. For example, the PED is likely to be at least an arm's length distance from the EGM 2. Thus, the EGM 2 can establish a connection with the PED 14 or 16 that can be used to facilitate a connection with a remote device via wide area networking capabilities provided by the PED 14 or 16.

After depositing credits, a player can make a wager and initiate a game on the EGM 2. The input panel 28 can be used to make selections related to the play of the game, such as a wager amount, and initiate the game. After the game is initiated, a game outcome presentation can be generated on EGM 2. It can include video images output to the displays and accompanying sound effects. For example, during a video slot game played on EGM 2, the game controller can generate a game presentation including a series of video images that show at different times an amount wagered on the game, symbols moving and then stopping in a final position and an award amount associated with game based upon the amount wagered and the final position of the symbols.

In some instances, after depositing credits, typically before beginning game play, a player can initiate a player tracking session on the EGM 2. During a player tracking session, information associated with game play, such as amounts wagered and amounts won can be stored to a player tracking account. This information is often referred to as player tracking information. To encourage repeat business, gaming enterprises often provide complimentary awards (“comps”), such as free meals and lodging, to players. The value of the comp can depend on the value of the player to the casino based upon their player tracking information, such as amounts wagered over time.

The player tracking account, player loyalty account, or specific player cash account at a casino can be associated with the user that has initiated game play on EGM 2 and can be hosted on a remote device, such as server. The player can initiate a player tracking session by providing player tracking account information that allows their player tracking account to be located on a device that hosts player tracking accounts. In one embodiment, the player tracking account information can be stored on the PEDs, 14 or 16, and transmitted to the EGM via a compatible communication interface. In another embodiment, the player tracking account information can be stored on a card that can be read by card reader 15. In yet another embodiment, a service window application can be used to enter player tracking account information.

In general, when a nearby PED is detected or the EGM 2 is made aware of a nearby PED (e.g., another device may detect the presence of the PED and transmit the information to the EGM), the EGM 2 may attempt to establish communications with the device and inform them of the capability of downloading the app enabled in the present disclosure for using financial card funding through a financial institution to fund the player loyalty account or the player specific casino account. In one embodiment, the EGM 2 can be configured to contact and attempt to access the wide area network capabilities of a PED. For instance, the EGM 2 can be configured to contact a PED associated with a player utilizing the EGM 2 use the wide area network capabilities of the PED to communicate with a remote device, such as a remote server.

During game play, the EGM 2 can be configured to send information to the PEDs, such as 14 or 16, which is for a player's personal use. For instance, the EGM 2 can be configured to send a copy of a screen displayed on 25 or 26 showing the outcome of the game or a bonus game. The player can save this screen copy as a keepsake and may optionally upload it to a social media site. Further, the EGM 2 can be configured to receive information from the PED that affects the game play. For instance, the EGM 2 can be configured to receive player tracking information, voucher information and/or player preference information that allows the gaming experience to be customized for a particular player. Thus, the EGM 2 can be configured to interact with a PED to send data intended for storage on the PED as well as to send data to the PED that is intended for a remote device.

Communications Topologies in a Gaming System Including Portable Electronic Devices

Different communication topologies involving PEDs in a gaming system are described. In one embodiment, PEDs, such as 14 or 16, can communicate directly with the EGM. For example, as described above, the communications can be through a wired or wireless interface available on the EGM. Via an EGM to PED communication interface, the PED may be able to communicate with the game controller on the EGM, a secondary controller on the EGM, a remote device, such as server 4 or combinations thereof. Examples of a secondary controller include but are not limited to a player tracking controller, a card reader controller, a bill validator controller, a printer controller, or from a Quick Response (QR) Code reader and any similar or new technologies that allow interactions of these devices and/or similar devices not yet invented. In the case of the remote device, such as server 4, the EGM 2 can act as an intermediary in the communications.

In one embodiment, for security purposes, the EGM 2 can be configured to not allow direct communications between the game controller and the PED. For example, the PED may communicate with a secondary controller in a secondary device coupled to the EGM, such as a card reader controller in a card reader. The secondary controller may include a communication interface that allows it to communicate with a remote device, such as server 4. In a particular embodiment, the communications between the secondary controller and the game controller can be well defined to limit the type of information that is transferred the secondary controller and the game controller. Depending on how the communications are defined, the EGM 2 may be able to receive limited types of information or not any information from the PED via the secondary controller.

In another embodiment, the communications between the PED and the EGM 2 can be unidirectional. For example, the EGM can be configured to directly send information to the PEDs, such as 14 or 16, but not directly receive information from the PED. In one embodiment, information can be sent from a PED to an EGM 2 via an intermediary device, such as server 4 or a secondary device, such as card reader 15. The intermediary device can be configured to screen and limit the information from the PED that can be received by the EGM 2.

In yet other embodiments, the EGM 2 and the PEDs may only communicate indirectly using the communication capabilities associated with a PED. For example, PEDs may be able to establish communication connection with server 4 which then acts as intermediary for communications between the PEDs, such as 14 and 16, and EGM 2. The EGM 2 can be configured to output information via a display device or some other mechanism that enables the indirect PED to EGM communications via an intermediary device, such as server 4, via a local area network, such as 6, or via a wide area network, such as 52. For example, the EGM can be configured to output a QR code that a PED can scan. Information embedded in the QR code can allow the PED to establish communications with the EGM 2 via server 4, local area network 6 or wide area network 52.

The PEDs can communicate with a device, such as server 4, using one of its inherent communication capabilities. The mode of communication that is used can vary depending on the communication networks 50 that are available to the PEDs. For example, the server 4 and EGM 2 can be located on a local area network, such as a local area network 6 within a casino. The local area network can be a private network only accessible from the casino and its vicinity. Via wireless access point 54, the PED can access the local area network, such as 6 to access the server 4 or optionally EGM 2. Thus, via wireless access point 54, the PED may be able to communicate with 1) a server 4, 2) an EGM 2 where the server 4 acts as intermediary in the communications or 3) directly with the EGM 2 via the local area network 6.

In other embodiments, the server 4 and/or the EGM 2 can access a wide area network, such as the Internet 52 and have an Internet Protocol (IP) address such as IPv4 and/or IPv6. Via the wireless access point 54 or a cellular data connection 56, the PED, such as 14 or 16, can access the Internet 52 to establish communications with server 4 or EGM 2. Again, the server 4 can act as intermediary in the communications between the PED and the EGM 2. Thus, the PEDs can establish communications with server 4 via the Internet 52 and then, the server 4 can establish communications with the EGM 2 using an alternative method.

In various embodiments, different EGMs in a gaming system can be provided with different communication capabilities. Thus, a combination of the communication topologies used above can be used for communications between PEDs and EGMs in a gaming system. For instance, a PED can communicate with a first EGM via a direct wireless connection between the first EGM and the PED and then communicate with a second EGM via a wireless access point that connects to a local area network on which the second EGM is located, including but not limited to any similar and/or standard and accepted secure network topologies.

Entering Sensitive Information for an Electronic Gaming Machine From a Portable Electronic Device

In accordance with the present invention, details of EGMs, gaming systems and the Portable Electronic Devices (PED) are described herein. Initially, a player/patron may initiate a transaction on an EGM that requires the input of Sensitive Information (SI) in order to further continuance of that transaction. Such secure transactions, for example, include, but are not limited to, the commencement or continuance of game play, player tracking transactions, accounting transactions, cash-outs, cash transfer transactions, player club operation transactions or an enrollment transaction for a promotion, etc.

Due in part to the close proximity of the EGMs relative to one another, some patrons are reluctant to enter their SI in front of other patrons, and may elect to forego participation on the EGM altogether. Accordingly, by enabling the input of such SI directly onto their own PED (which will be the only one discussed henceforth for the ease of description), which is in direct communication with the EGM, such input is significantly more discrete, and out generally of the plain view of other patrons.

Once a transaction has been initiated on the EGM, depending upon the specific transaction requiring player information, the EGM and/or system server will determine whether or not the player information is SI or not. Should the required player information not be determines SI, the EGM may enable input of such information directly on the EGM using the player input panel and/or other input controls.

In accordance with the present invention, however, should the required player input information include SI, then the communication between the EGM (and/or system server 4) and the PED 14 may commence in order to enable input of the SI data directly on their PED. In one embodiment, to establish communication, the player/patron may simply execute a mobile app from their PED that was previously downloaded from one of the various mobile application sites, depending upon whether the mobile OS is Apple, Android, Blackberry, Palm or Microsoft based, etc. Using such an executable application installed on the mobile device that enables aforementioned SI input features, the EGM can effectively communicate with the mobile application to enable the SI exchanged.

In other embodiments, an installed mobile application may not be desirable given the various mobile device platforms (e.g., Android, iPhone, etc.) or the player/patron simply not wanting a gaming application on their PED. In these versions, the EGM 2 and/or the system server 4 could commence communication with the PED 14 using at least two different technologies. Appling a standard communication protocol/technology, the EGM can communicate directly with the PED's web browser, using HTML. For example, once player/patron has entered the SI into the PED, the SI is forwarded to the EGM through HTML using the PED's web browser.

Once communication between the PED and the EGM/Server has commenced and established, using at least one of the above mentioned techniques and technologies, a Greet Screen 102 can be formatted and output to the PED for viewing on the PED's display. In one configuration, the resolution, size, aspect ratio, etc., of the SI input screens can be formatted and output in a lower quality, more universal format that is capable of being displayed on a wide range of PED displays, regardless of the display's resolution, size, aspect ratio, etc.

A general query to input the SI data is also prominently placed on the Greeting Screen. This facilitates the ease of input and use by the player/patron, informing them what input SI data is required. For example, the Greeting Screen 102 includes a request to “Please enter PIN on Your Mobile Device” message. Briefly, the requested SI data for input is a PIN although it will be appreciated that any form of SI could be requested. As mentioned, such input SI data includes, but is not limited to, the patrons account, name, address, social security, password, phone number, biometric input, etc. or any other personal identification information.

Depending upon the type of PED and its' input controls (i.e., whether the device includes a hard numbered keypad, a keyboard, a touch sensitive display and/or combination thereof), or any other form of input acceptable to the PED how the actual entrance of the input SI data may vary from device to device. The PED may incorporate a full touch screen style input. Therefore, to advance to the next input screen, the patron may have to contact the “Press to Start” message or some other form for screen continuance.

Applying conventional validation/invalidation comparison technology, the validation of the input SI data may be assessed. Should the input SI data be determined “Invalid” for whatever reason, an Invalidation Screen may be rendered on the PED display. A simple invalidation message such as an “Invalid PIN Entry” message can be displayed for information, as well as a “Please Re-enter Your PIN” message before reverting back to the SI input Screen. The player/patron may then reenter their sensitive input SI data again.

In one specific embodiment, the validation could be performed in-part on the PED itself. Using

HTML, XML, PHP, or similar markup language, programming language or similar to be used in device to device communication, the client on the PED performs partial validation of the data, and then the server still requires validation. For example the client might prompt the play/patron for a number, which may relate to the play/patron's age. The client on the PED compares the PED stored number to the input SI (e.g., only validating when values 0 through 9 are entered and not when letters are entered). The client, for instance, might even check that the input age is greater than one and less than 150. The server would likely perform the same check but also compare the age against a database for the user.

Similar to other forms of sensitive personal identification information, should an invalid entry continue a predetermined number of attempts (e.g., 4 or 5 consecutive attempts), the system may “lock-out” further entry of input SI data from that PED for a predetermined period of time or until other circumstances are met. These other circumstances may include a password or pass code reset or other verification techniques.

Should the input SI data be determined “Valid” by the EGM/Server, a Validation Screen may be rendered on the PED display. Again, a simple validation message may be displayed such as a “Valid PIN Entry Congratulations!” message. Once the player/patron has been informed of their validation, they may proceed with the furtherance of their transaction, either on the PED itself or on the EGM. For instance, the player/patron may be informed of such furtherance by a “Please Proceed with Your Transaction” message on the PED display.

In one configuration, should the SI input cycle be complete, the EGM/Server, or the PED mobile application, may timeout, reverting the PED back to the home screen or the like. Moreover, should the player/patron be required to reenter the input SI data on their PED, such in SI data may be stored, and automatically complete entry of the input SI data in the data slots of the SI display region.

Methods in Association with an EGM and Server

Next details of a method on an EGM and server involving the input of Sensitive Information (SI) for the EGM on a mobile app on a Portable Electronic Device (PED) are described. A method enters such SI from the PED through the EGM or directly to the financial institute supporting the financial card. A request may be received through the EGM or directly from the mobile app on the PED to initiate a transaction. For instance, the player/patron at the EGM may operate the player input panel on the PED making inputs associated with the execution of the mobile app to initiate the financial transfer procedures described and enabled herein, including entry in response to any requests for information. Some requested information and transactions may not require the input of SI data, to further continue the transaction, such as dining requests, game selection, game operation, chatting, beverage selection or browsing casino offerings. However, as mentioned above, many transactions do require the input of SI, such as the play of communal games, player tracking transactions, accounting transactions, cash-out transactions, mobile money transfers transaction, general account settings transactions, and/or password or pass code recovery transactions, etc.

However, in accordance with the present invention, should the requested transaction require the input of SI data, communications can be established with and through a PED. In one embodiment, a secure pairing between the PED and the EGM or the financial institution can be established using a protocol such as Bluetooth™ or Wi-Fi. If present, an NFC enabled communication interface on the EGM can be used to transfer information that allows a secure pairing to be established. In another embodiment, communications between the mobile device and the EGM can be enabled via an intermediary device. For instance, communications can first be established between a mobile device and a remote server and then communications can be established between the remote server and the EGM such that information can be transmitted between the EGM and the mobile device.

In either event, a predetermine response time period may commence once each screen is output to the PED for viewing on the PED display. The EGM may determine whether one or more response time periods have been exceeded. Should the player/patron fail to input any information or fail to input any key stroke on the PED display after the predetermined time period (e.g., 2 minutes), the EGM will automatically “timeout”, ending the transaction. In one embodiment, the system can inform the player/patron of the “timeout” on the PED display and/or the EGM display, and then perhaps revert to the EGM Home Screen or in the like.

Similarly, in the event of a failed or broken communication between the EGM and the PED, the PED will also “timeout”, ending the transaction. In this event, the EGM may again similarly inform the player/patron of the failed or broken communication on the EGM display, and then perhaps revert to the EGM Home Screen or in the like.

Should the “received” input SI data be determined “Invalid”, the PED will output screen content to the PED, informing the player/patron of the invalid input SI data entry (Invalidation Screen). Subsequently, the EGM will output the SI Input Screen back to the PED.

In the event that the “received” Input SI is determined valid, the PED will output screen content to the PED, informing the player/patron of the valid input SI data entry (i.e., Validation Screen). Subsequently, the PED and the financial institution will permit further continuation of the transaction. The communication through the app in the PED then can be ended at the conclusion of the transfer.

A central server in the casino, associated with the player loyalty program can determine whether an account and/or EGM is associated with the PED, and establish communications that allows information to be transmitted between the PED and the account and/or the EGM. For instance, the server can receive a request from the EGM to establish communications with the PED in response to detecting a presence of the PED.

(Gagner) [0051] FIG. 1 is a block diagram illustrating account transactions, according to example embodiments of the invention. In FIG. 1, a wagering game machine 102 is connected to a casino account controller 104, which is connected to a financial institution computer 106 which is, in turn, connected to the personal electronic device (not shown). The wagering game machine 102 provides a graphical user interface 108 through which players request account transactions and may create account rules. The account server 104 facilitates the account transactions and enforces the account rules, while the financial institution computer 106 also facilitates account transactions.

FIG. 1 shows two transactions. In the first transaction (see “1^{ST}” in FIG. 1) a player (not shown) uses the interface 114 to request transfer of $500 from a financial card account 114 to a player specific betting venue account (not shown) and then to a game session account 110. After the wagering game machine 102 receives the player's request, the machine 102 notifies the account controller 104 about the request. As a result, the account controller 104 contacts the financial card financial institution computer 106, which transfers $500 from the player's credit availability account 114 to the player's game session account 110. Funds in the game session account 110 appear on the wagering game machine's credit meter 118 and are available for use in wagering games presented on the wagering game machine 102.

In the second transaction (see “2^{ND}” in FIG. 1), the player configures an account rule in the user interface 108. The account rule prompts transfer of $20 from the player's game session account 110 to his §529 account 116 for every $100 won playing wagering games. For information about §529 accounts, see section 529 of the United States Code, which governs Qualified State Tuition Programs. The wagering game machine 102 notifies the account controller 104 about the account rule. The wagering game machine 102 also notifies the account controller 104 whenever the player wins money playing wagering games. When the player's winnings reach $100, the account controller 104 transfers $20 from the game session account 110 to the §529 account 116. The account controller 104 can support other account rules. In some embodiments, account rules can transfer a percentage of winnings from the game session account 110 to the §529 account 116. For example, if a player win ten cents in a single game, twenty percent (two cents) is transferred into the §529 account 116.

Example Operating Environment

This section describes an example operating environment and provides structural aspects of some embodiments. This section includes discussion about wagering game machine architectures and wagering game networks.

Wagering Game Machine Architecture

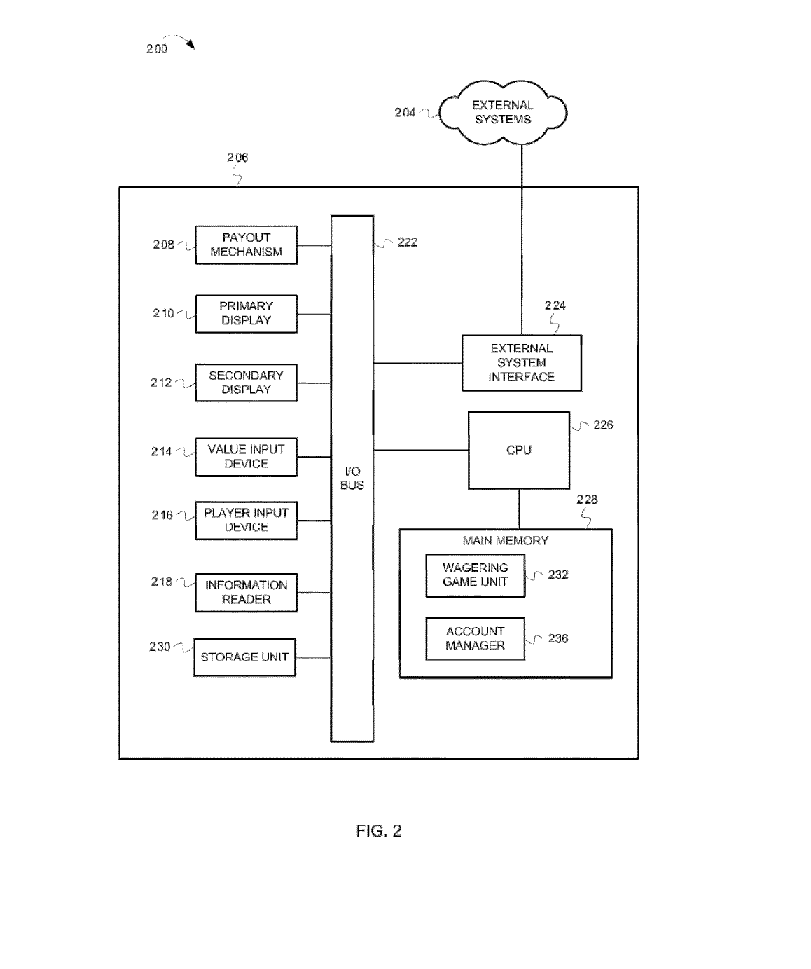

FIG. 2 is a block diagram illustrating wagering game machine architecture, according to example embodiments of the invention. As shown in FIG. 2, the wagering game machine architecture 200 includes a wagering game machine cabinet 206, which includes a central processing unit (CPU) 226 connected to main memory 228. The CPU 226 can include any suitable processor, such as an Intel™, Pentium III processor, Intel™ Core 2 Duo processor, AMD Opteron™ processor, UltraSPARC™ processor, etc. The main memory 228 includes a wagering game unit 232 and an account manager 236. In some embodiments, the wagering game unit 232 can present wagering games, such as video poker, video black jack, video slots, video lottery, etc., in whole or part. In some embodiments, the account manager 236 provides a user interface through which players can request account transactions and configure account rules. For example, players can request funds transfers between various accounts, such as game session accounts, checking accounts, savings accounts, .sctn.529 accounts, charity accounts, etc. The account rules can cause transfers and other transactions to occur when specific conditions are met. For example, account rules can initiate funds transfers when players wager specific amounts, win specific amounts, play a specific number of wagering games, etc.

The CPU 226 is also connected to an input/output (I/O) bus 222, which can include any suitable bus technologies, such as an AGTL+ frontside bus and a PCI backside bus. The I/O bus 222 is connected to a payout mechanism 208, primary display 210, secondary display 212, value input device 214, player input device 216, information reader 218, and storage unit 230. The player input device 216 can include the value input device 214 to the extent the player input device 216 is used to place wagers. The I/O bus 222 is also connected to an external system interface 224, which is connected to external systems 204 (e.g., wagering game networks).

In one embodiment, the wagering game machine 206 can include additional peripheral devices and/or more than one of each component shown in FIG. 2. For example, in one embodiment, the wagering game machine 206 can include multiple external system interfaces 224 and/or multiple CPUs 226. In one embodiment, any of the components can be integrated or subdivided.

Any component of the architecture 200 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

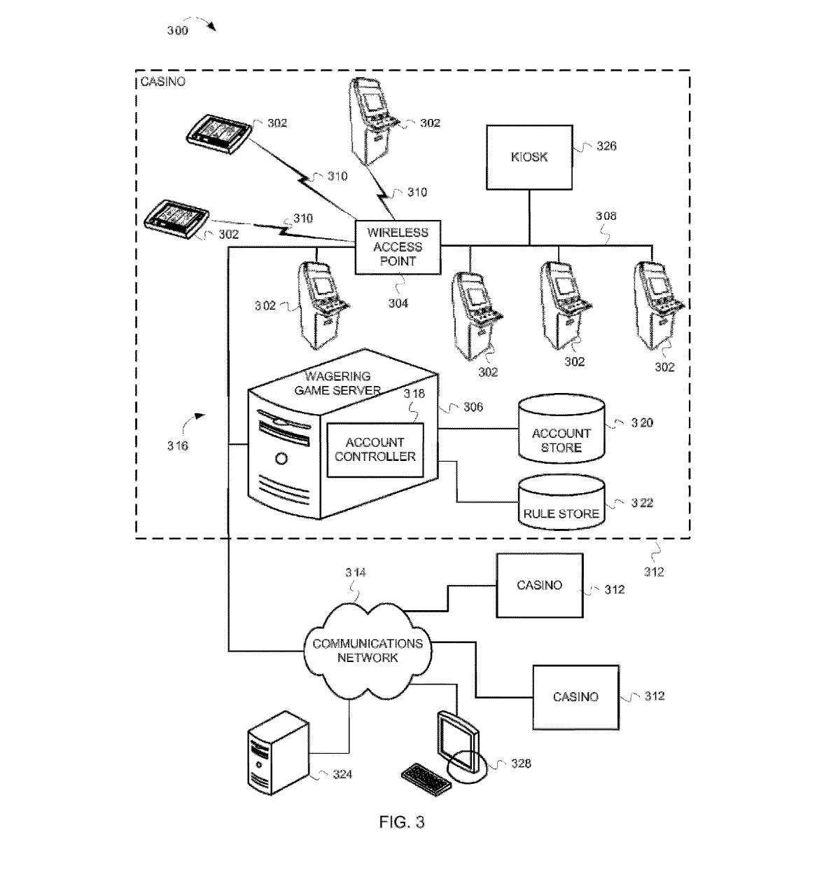

While FIG. 2 describes example embodiments of a wagering game machine architecture, FIG. 3 shows how a plurality of wagering game machines can be connected in a wagering game network.

Wagering Game Network

FIG. 3 is a block diagram illustrating a wagering game network 300, according to example embodiments of the invention. As shown in FIG. 3, the wagering game network 300 includes a plurality of casinos 312 connected to a communications network.

Each of the plurality of casinos 312 includes a local area network 316, which may include a wireless access point 304, wagering game machines 302, and a wagering game server 306 that can serve wagering games over the local area network 316. The wagering game server 306 includes an account controller 318, which can facilitate account transactions and enforce account rules. The account controller 318 can communicate with other network components, such as the financial institution computer 324, when enforcing account rules and processing transactions. Also, the account controller 318 can record, modify, and use account information in the account store 320 and rule store 322. In some embodiments, the account controller 318, account store 320, and the rule store 322 can be located outside the casino 312.

The local area network 316 includes wireless communication links 310 and wired communication links 308. The wired and wireless communication links can employ any suitable connection technology, such as Bluetooth, 802.11, Ethernet, public switched telephone networks, SONET, USB, arcnet, current loop, etc. In one embodiment, the wagering game server 306 can serve wagering games and/or distribute content to devices located in other casinos 312 or at other locations on the communication network. 314.

Any of the wagering game network components (e.g., the wagering game machines 302) can include hardware and machine-readable media including instructions for performing the operations described herein.

The wagering game machines 302 described herein can take any suitable form, such as floor standing models, bar-top models, banked machines, theater arrays of terminals, workstation-type console models, etc. Further, the personal electronic device can be primarily dedicated for use in conducting wagering games, or can include non-dedicated devices, such as mobile phones, personal digital assistants, tablets, smart phones, personal computers, etc. In one embodiment, the wagering game network 300 can include other network devices, such as accounting servers, wide area progressive servers, player tracking servers, and/or other devices suitable for use in connection with embodiments of the invention.

In various embodiments, wagering game machines 302 and wagering game servers 306 work together such that a wagering game machine 302 may be operated as a thin, thick, or intermediate client. For example, one or more elements of game play may be controlled by the wagering game machine 302 (client) or the wagering game server 306 (server). Game play elements may include executable game code, lookup tables, configuration files, game outcome, audio or visual representations of the game, game assets or the like. In a thin-client example, the wagering game server 306 may perform functions such as determining game outcome or managing assets, while the wagering game machine 302 may be used merely to present the graphical representation of such outcome or asset modification to the user (e.g., player). In a thick-client example, game outcome may be determined locally (e.g., at the wagering game machine 302) and then communicated to the wagering game server 306 for recording or managing a player's account.

Similarly, functionality not directly related to game play may be controlled by the wagering game machine 302 (client) or the wagering game server 306 (server) in embodiments. For example, account transactions and account rules may be managed centrally (e.g., by the wagering game server 306) or locally (e.g., by the wagering game machine 302). Other functionality not directly related to game play may include power management, presentation of advertising, software or firmware updates, system quality or security checks, etc.

Operations and Interfaces

This section describes operations and interfaces associated with some embodiments of the invention. In the discussion below, the flow diagrams will be described with reference to the block diagrams presented above. In certain embodiments, the operations are performed by executing instructions residing on machine-readable media (e.g., software), while in other embodiments, the operations are performed by hardware and/or other logic (e.g., firmware). In some embodiments, the operations are performed in series, while in other embodiments, one or more of the operations can be performed in parallel. Furthermore, the discussion below describes communications between wagering game network components. In some embodiments, the communications can include HyperText Transport Protocol (HTTP) requests for Hypertext Markup Language (HTML) documents. However, in other embodiments, the communications can be formatted according to different communication protocols.

The section will discuss FIGS. 4-7. FIGS. 4-6 will describe operations and interfaces for performing account transactions in response to player input.

FIG. 4 is a flow diagram illustrating operations for facilitating account transactions on a wagering game machine through a user interface, according to example embodiments of the invention after the credit card fund transfer according to the present technology has been accomplished. The flow diagram 400 will be described with reference to the FIG. 3's wagering game network and FIG. 2′s wagering game architecture. The flow begins at block 402.

At block 402, a wagering game machine 302 detects a player identifier. The wagering game machine 302 may detect the player identifier as a result of a player swiping a player account card, manually entering the identifier, or providing some other device that indicates the player identifier (e.g., an RFID tag). The flow continues at block 404 after the credit card fund transfer according to the present technology has been accomplished.

At block 404, the wagering game machine 302 receives a list of wagering game accounts and other accounts associated with the player identifier. In some embodiments, the wagering game machine's account manager 236 requests and receives the list from the account controller 318. The flow continues at block 406.

At block 406, the wagering game machine 302 presents a graphical representation of the wagering game accounts and/or other accounts enumerated in the list. For example, the wagering game machine's account manager 236 presents, on the primary display 210, a user interface including graphics that represent financial accounts associated with the player identifier. FIG. 5A shows one such user interface.

FIG. 5A is a block diagram illustrating a graphical user interface through which players can request account transactions from a wagering game machine, according to example embodiments of the invention. In FIG. 5A, the graphical user interface 500 appears on a wagering game machine's touchscreen 502. As shown, the user interface 500 includes graphics representing accounts associated with a player identifier. The graphics include a game session account icon 504, savings account icon 506, casino account icon 508, .sctn.529 account icon 510, and money market account icon 512. The GUI 500 can show icons for any number of financial accounts. The accounts can include a game session account, casino debit/credit accounts, checking accounts, savings accounts, educational savings accounts (e.g., a .sctn.529 account), charity accounts (e.g., accounts that aid responsible gaming programs), holiday savings accounts, etc. According to embodiments, players can request account transactions by interacting with the icons.

At block 408, the wagering game machine 302 detects a request for information about the wagering game account and/or other accounts. For example, the account manager 236 detects that a player has activated an icon in the user interface. The flow continues at block 410.

At block 410, the wagering game machine 302 receives account information associated with the account access request. The account information can include an account balance, transaction options associated with the account, and other information related to the account. In some embodiments, the account manager 236 requests and receives the account information from the account controller 318. Flow continues at block 412.

At block 412, the wagering game machine presents a graphical representation of the account information. To illustrate this concept, FIG. 5B shows how some embodiments can present account information including transaction options in a GUI.

FIG. 5B is a block diagram illustrating account information in a wagering game machine's graphical user interface, according to example embodiments of the invention. Players can activate the account icons by pressing the touchscreen 502. After an account icon is activated, the interface 500 presents additional account transaction options, which are represented by additional icons. In FIG. 5B, the player 518 has activated the savings account icon 506. As a result, the interface 500 has presented a savings account balance 520 and currency icons 514, which allow the player 518 to transfer different denominations between a savings account and other accounts. As shown, the player 518 is dragging a $20 currency icon 516 into the game session account icon 504. This drag-and-drop operation constitutes a request to transfer $20 from the player's savings account into the player's game session account. The GUI 500 supports similar drag-and-drop operations to request other transfers.

Moving back to FIG. 4, at block 414, the wagering game machine 302 detects a transaction associated with the account options. For example, the account manager 236 detects a drag-and-drop operation that signifies an account transaction request. The drag-and-drop operations can indicate all parameters needed to request an account transaction. For example, drag-and-drop operations can indicate a transaction type, source account, destination account, currency amount, etc. The flow continues at block 416.

At block 416, the wagering game machine 302 transmits an indication of the transaction request, so the wagering game account and/or other accounts can be adjusted. For example, the account unit 236 transmits, to the account controller 318, an indication of the transactions that the player requested via the user interface. From block 416, the flow ends.

Thus far, this section has described account operations typically performed by wagering game machines. This section will continue with a discussion about account operations that are typically performed by account controllers.

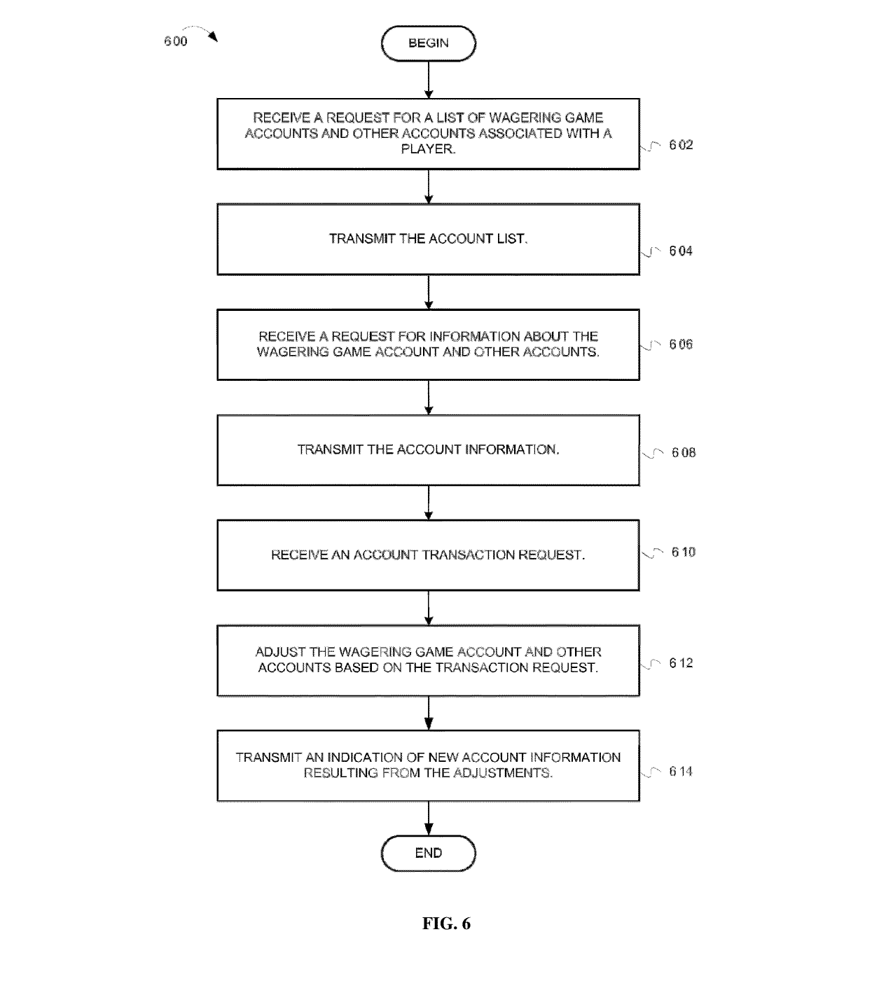

FIG. 6 is a flow diagram illustrating operations for processing account transactions made at a wagering game machine, according to example embodiments of the invention. The flow 600 describes operations by which an account controller transmits information to wagering game machines. In some embodiments, the wagering game machines include logic for presenting the information (e.g., see discussion of FIG. 4). In other embodiments (e.g., where the wagering game machine includes a thin client) the account controller can control presentation of the information on the wagering game machines. The flow 600 begins at block 602.

At block 602, the account controller 318 receives (from a wagering game machine 302) a request for a list of wagering game accounts and other financial accounts associated with a player. The flow continues at block 604.

At block 604, the account controller 318 transmits the account list to the wagering game machine 302. As noted above, in some embodiments, the account controller 318 may control presentation of the account list on the wagering game machine 302. The flow continues at block 606.

At block 606, the account controller 318 receives a request for information about the wagering game account and other accounts. For example, the request may ask for account balances, transaction options, and information about recent transactions, etc. The flow continues at block 608.

At block 608, the account controller 318 transmits the account information to the wagering game machine 302. The flow continues at block 610.

At block 610, the account controller 318 receives an account transaction request from the wagering game machine 302. For example, the account controller 318 receives a request to transfer funds from the player's savings account that has been funded through the mobile app operating with the assuring financial institute for the financial card to the player's game session account. The flow continues at block 612.

At block 612, the account controller 318 adjusts the accounts based on the transaction request. For example, the account controller 318 instructs the financial institution computer 324 to deliver funds from a savings account to a game session account. In some embodiments, the account controller 318 does not transfer funds directly into game session accounts. Instead, the account controller 318 deposits funds into other wagering game accounts. Later, the account controller 318 can transfer funds from the wagering game accounts to game session accounts, if needed. The flow continues at block 614.

At block 614, the account controller 318 provides account information indicating the results of the requested transactions. For example, the account controller 318 notifies the player that funds have been transferred between the player's savings account and game session account. The account controller 318 can notify the player by sending a message to the wagering game machine 302. In some embodiments, the wagering game machine 302 will update its credit meter or other related balances accordingly. From block 614, the flow ends.

Some embodiments of account rules enable players to submit rules that automatically initiate account transactions when certain conditions are met, both before and after the credit card fund transfer according to the present technology has been accomplished. In some embodiments, the account rules specify account transactions, source and destination accounts, amounts, and trigger conditions. The account transactions can include transfers, deposits, withdrawals credits, debits, etc. When appropriate, source and destination accounts are identified (e.g., for transfers). Trigger conditions indicate when rules should be enforced. Trigger conditions can relate to time, account balances, wagering game results, wagers placed, and any other statistic associated with wagering game accounts, other financial accounts, and wagering games.

In some embodiments, players can use account rules to limit losses. For example, a player can create account rules that limit how much money can be transferred from a checking account into a game session account. Alternatively, players can move a portion of each winning jackpot from a game session account into savings account, where the savings account does not support wagering-game-related withdrawals. Players can also create account rules that transfer percentages of winnings to fund savings plans, charities, and other programs (e.g., responsible gambling programs). Furthermore, in some embodiments, players can create account rules that, at the conclusion of a gaming session, automatically transfer the entire game session account balance to another account, such as a casino debit account, checking account, or the like. As a result, embodiments eliminate the need for wagering game machines to return cash or cashless vouchers at the end of gaming sessions.

By utilizing a marketing system with the profile database of the method and system described, each player's use of their comps, casino promotions, how often then visit the casino and how much they transfer may be categorized in a database system into customized profiles. This data is all individualized even within each player's profile. Moreover, a player may receive offers, in the special offers and promotional section of the application. For example, a player could receive a dinner and show offer that is complete with all of the player's business/personal profile criteria met including special offers from restaurants and entertainment vendors. More specifically, he/she could be offered a trip to the casino with comped rooms, restaurant offers, entertainment offers, and shopping offers within one package offer. With each new piece of data entered via players preference input or precision data captures made by the mobile app and stored into his/her profile, the system develops a more precise understanding of the player's preferences. Therefore, the offers will become more accurate over time. The system and method described is primarily used to induce players to return to spend more money at one or more of his/her elected casino locations, invite others to do the same, and market to each player's specific needs based on his/her specific preferences. The casino can make the best use of the system in this way without incurring exorbitant printing, mailing, demographic list generating, and other extraneous marketing costs.

When the player arrives, the customer identifies himself/herself by initiating a funds transfer or his/her mobile device GPS identifies they are within a specified range of the casino. Therefore, for example, the player may receive a free show offer for that night after a transfer from the mobile app has been made or if they are in the vicinity of the casino. Traditionally, this type of promotion would be a tracking nightmare. As another example, an automatic complimentary dinner offer may be triggered by a casino host. While traditional in-house promotions become cost-prohibitive and obsolete, the method of the invention provides inventory controls and other cost saving triggers as ancillary benefits from collecting the customer data. Therefore, also being a customer loyalty marketing campaign. The functionality can be customized to various loyalty card programs, including concepts such as: player can request a valuation cost for meals, services, room services, spa services, or any other POS within the casino and allowing the player to assess whether or not to redeem points for said services or goods, or to retain the points for a future expenditure. Additionally, players can redeem the accumulated points or available cash for wagering, expenditures at any POS within the casino system, or monitor the increases throughout the player's stay at the casino. As an example, a player wishes to have a dinner at one of the Casino facilities. Upon opening PlayPal™ systems, he determines that he has an accumulated value of 250,000 points earned from play or comped to his account by the Casino. The estimated cost of a dinner for two at the facility can be ascertained through PlayPal™ system, for the use of this Abstract, would be 500,000 points. At this juncture, the player can load their Loyalty Club account with the additional 250,000 points through a bank transfer of funds, or a credit card advance of funds to their account, allowing the player to complete the transaction without having to split the billing between points and cash or credit card, or having to ask for a comp from a Casino host, which may or may not be granted.

PlayPal™ system can capitate the allowable funds which can be transferred to the players account. Additionally, PlayPal™ system will not allow transfer of funds when the Loyalty Club cards are active in a slot machine or at table games. These restrictions will control unwanted excesses of cash distributions, and encourage responsible gaming by the player and casino staff.

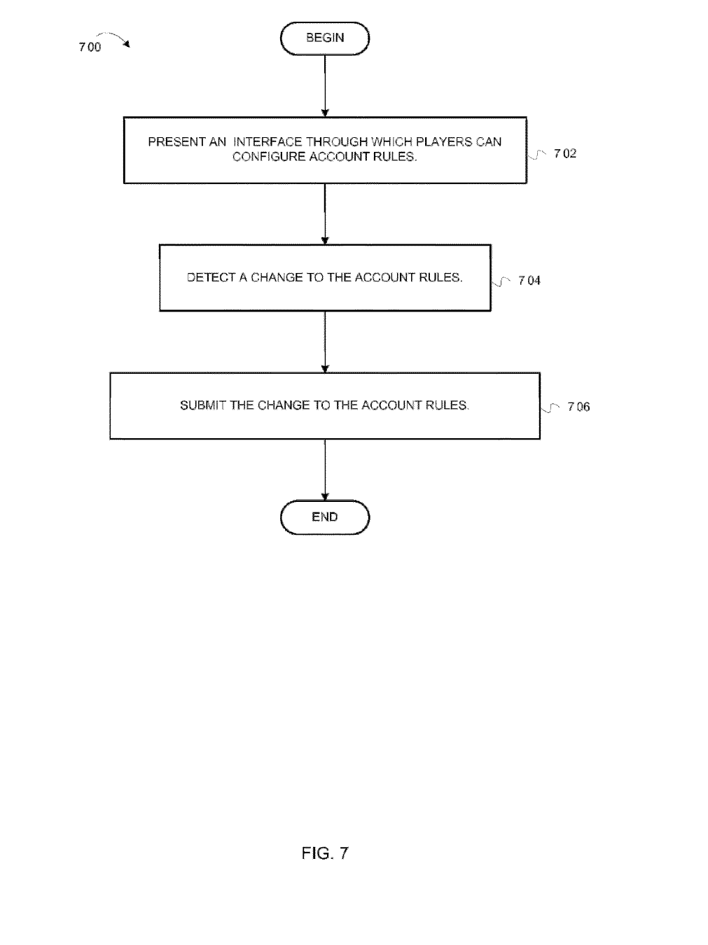

The following discussion will describe account rules in more details. In particular, the discussion of FIG. 7 will describe operations for presenting an account rule interface.

FIG. 7 is a flow diagram illustrating operations for presenting an account rule interface, according to example embodiments of the invention. The flow 700 begins at block 702.

At block 702, a wagering game machine 302 presents an interface through which players can view and configure account rules. In some embodiments, the account manager 236 and/or other components create the account rule interface and populate it with account information received from the account controller 318. In other embodiments, the machine 302 renders the account interface in a web browser, using information received from the account controller 318 or other network devices.

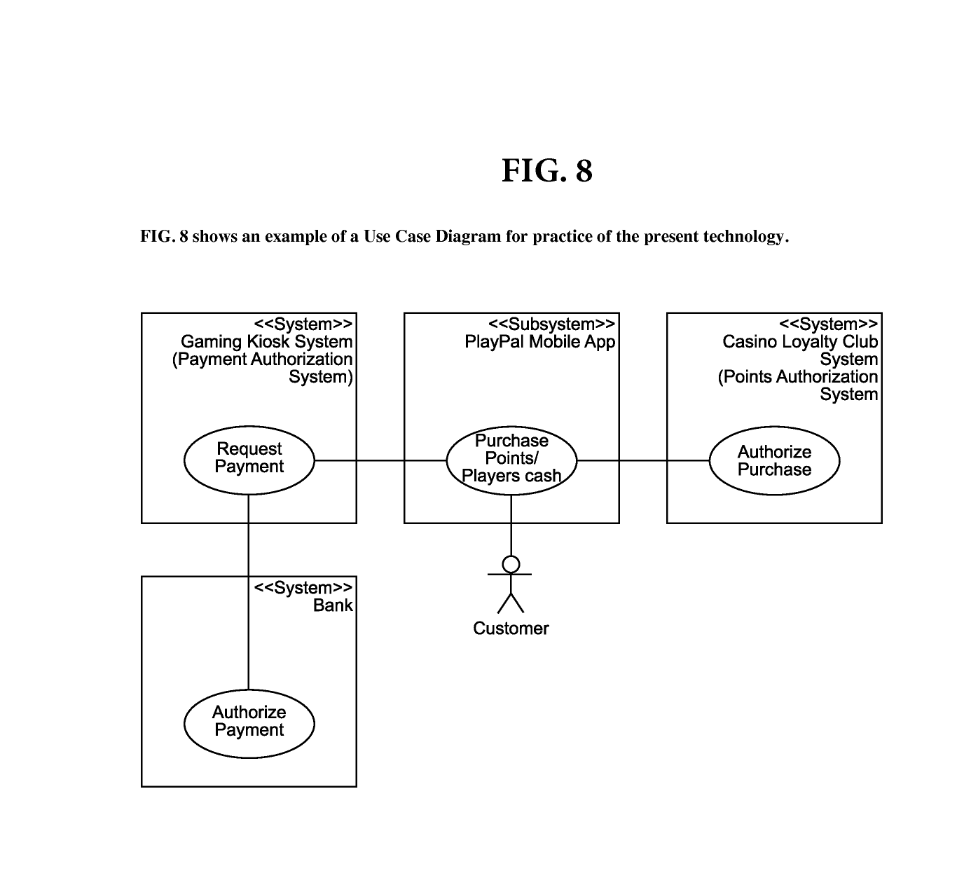

FIG. 8 shows an example of a Use Case Diagram for practice of the present technology.

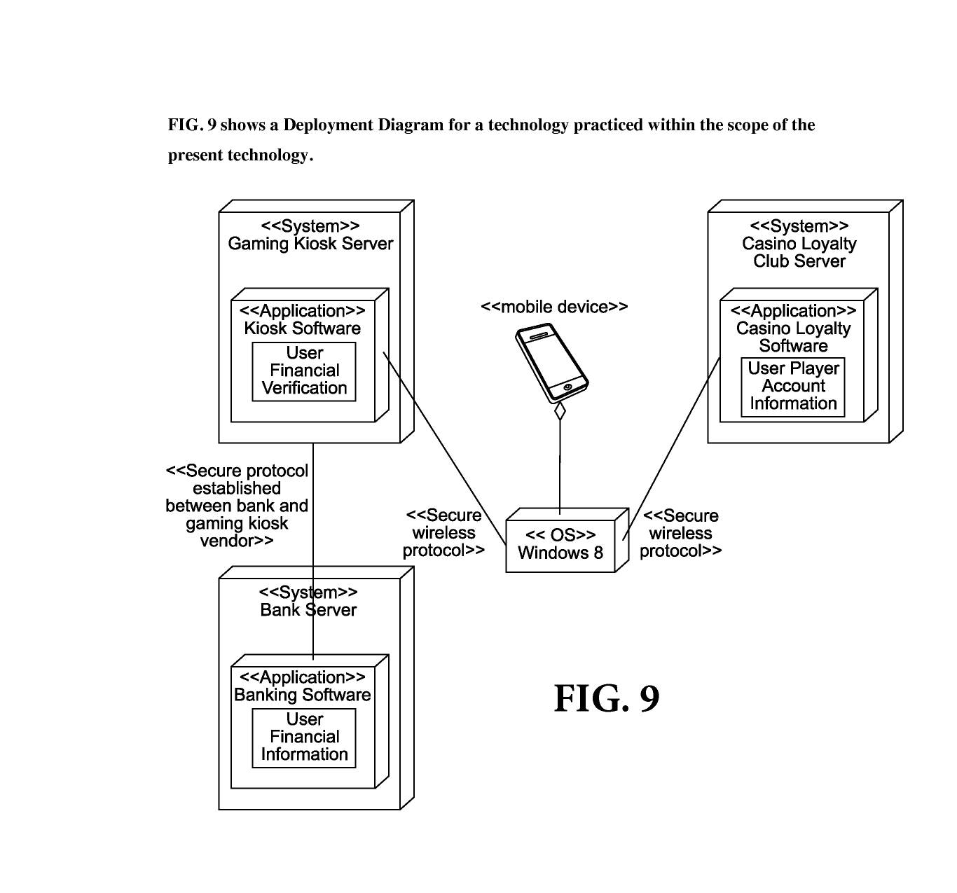

FIG. 9 shows a Deployment Diagram for a technology practiced within the scope of the present technology.

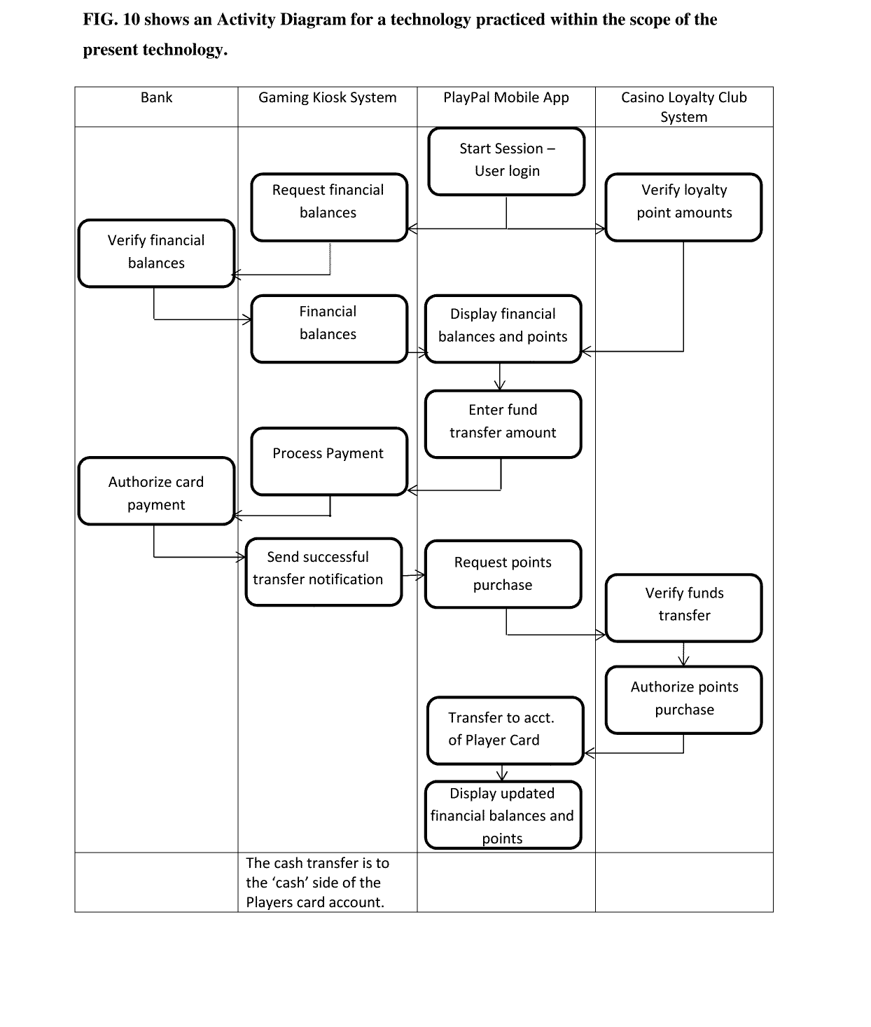

FIG. 10 shows an Activity Diagram for a technology practiced within the scope of the present technology.

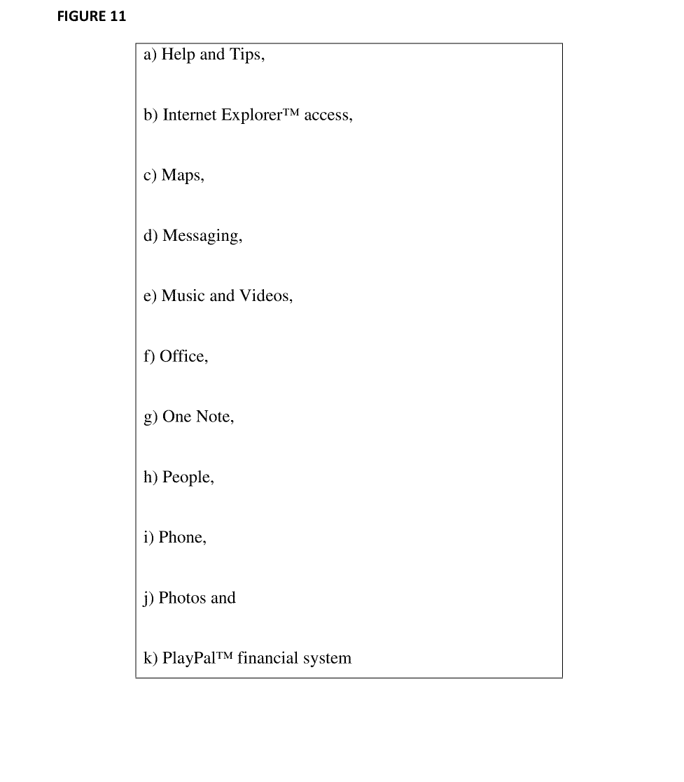

FIG. 11 shows a screen shot of a home screen for access to a technology practiced within the scope of the present technology and referred to by the name of PlayPal™ finance accounting system. From top to bottom on the screen is shown touchscreen sensitive icons enabling commands and access to a) Help and Tips, b) Internet Explorer™ access, c) Maps, d) Messaging, e) Music and Videos, f) Office, g) One Note, h) People, i) Phone, j) Photos and k) PlayPal™ financial system.

Example Wagering Game Machines

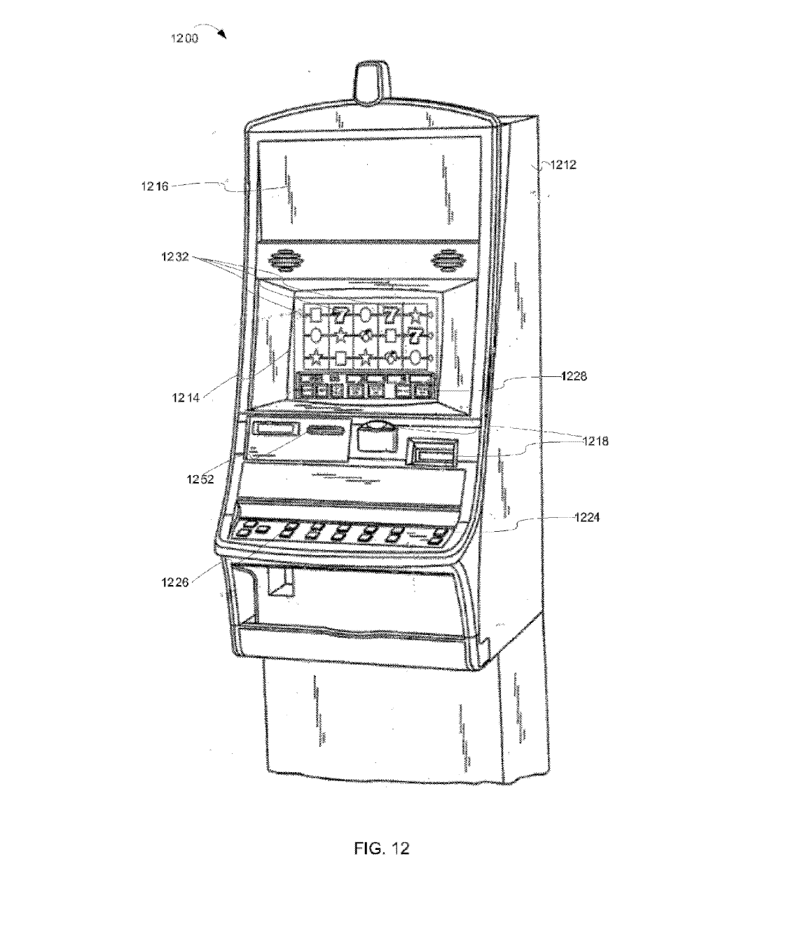

FIG. 12 is a perspective view of a wagering game machine, according to example embodiments of the invention. Referring to FIG. 12, a wagering game machine 1200 is used in gaming establishments, such as casinos. According to embodiments, the wagering game machine 1200 can be any type of wagering game machine and can have varying structures and methods of operation. For example, the wagering game machine 1200 can be an electromechanical wagering game machine configured to play mechanical slots, or it can be an electronic wagering game machine configured to play video casino games, such as blackjack, slots, keno, poker, blackjack, roulette, etc.

The wagering game machine 1200 comprises a housing 1212 and includes input devices, including value input devices 1218 and a player input device 1224. For output, the wagering game machine 1200 includes a primary display 1214 for displaying information about a basic wagering game. The primary display 1214 can also display information about a bonus wagering game and a progressive wagering game. The wagering game machine 1200 also includes a secondary display 1216 for displaying wagering game events, wagering game outcomes, and/or signage information. While some components of the wagering game machine 1200 are described herein, numerous other elements can exist and can be used in any number or combination to create varying forms of the wagering game machine 1200.

The value input devices 1218 can take any suitable form and can be located on the front of the housing 1212. The value input devices 1218 can receive currency and/or credits inserted by a player. The value input devices 1218 can include coin acceptors for receiving coin currency and bill acceptors for receiving paper currency. Furthermore, the value input devices 1218 can include ticket readers or barcode scanners for reading information stored on vouchers, cards, or other tangible portable storage devices. The vouchers or cards can authorize access to central accounts, which can transfer money to the wagering game machine 1200.

The player input device 1224 comprises a plurality of push buttons on a button panel 1226 for operating the wagering game machine 1200. In addition, or alternatively, the player input device 1224 can comprise a touch screen 1228 mounted over the primary display 1214 and/or secondary display 1216.

The various components of the wagering game machine 1200 can be connected directly to, or contained within, the housing 1212. Alternatively, some of the wagering game machine's components can be located outside of the housing 1212, while being communicatively coupled with the wagering game machine 1200 using any suitable wired or wireless communication technology.

The operation of the basic wagering game can be displayed to the player on the primary display 1214. The primary display 1214 can also display a bonus game associated with the basic wagering game. The primary display 1214 can include a cathode ray tube (CRT), a high resolution liquid crystal display (LCD), a plasma display, light emitting diodes (LEDs), or any other type of display suitable for use in the wagering game machine 1200. Alternatively, the primary display 1214 can include a number of mechanical reels to display the outcome. In FIG. 12, the wagering game machine 1200 is an “upright” version in which the primary display 1214 is oriented vertically relative to the player. Alternatively, the wagering game machine can be a “slant-top” version in which the primary display 1214 is slanted at about a thirty-degree angle toward the player of the wagering game machine 1200. In yet another embodiment, the wagering game machine 1200 can exhibit any suitable form factor, such as a free standing model, bartop model, mobile handheld model, or workstation console model.

A player begins playing a basic wagering game by making a wager via the value input device 1218. The player can initiate play by using the player input device's buttons or touch screen 1228. The basic game can include arranging a plurality of symbols along a payline 1232, which indicates one or more outcomes of the basic game. Such outcomes can be randomly selected in response to player input. At least one of the outcomes, which can include any variation or combination of symbols, can trigger a bonus game.

In some embodiments, the wagering game machine 1200 can also include an information reader 1252, which can include a card reader, ticket reader, bar code scanner, RFID transceiver, or computer readable storage medium interface. In some embodiments, the information reader 1252 can be used to award complimentary services, restore game assets, track player habits, etc.

A method, apparatus and system are used to provide funds to a player at a gaming apparatus. A portable electronic device is provided with an app through which is sent a wireless communication to a funding establishment that supports a financial card. The wireless communication contains data that identifies a) a specific financial card and a specific account established at a gaming facility where the gaming apparatus is located and b) an amount of funds to be applied against the financial card and transferred to the specific financial account. The specific financial account electronically transfers funds to the gaming apparatus for available use by the player upon command by the player to the specific financial account. The player profile database is comprised of mainly player inputted preference and gaming trends data which is stored into each player's profile and can be accessed/verified with a GPS recognition of the player's phone, biometric hand or finger scan, access card, retinal scan, password, or other terminal kiosk, touch screen, or mobile application of the like. PlayPal™ increases the convenience and usability of a Loyalty Club by increasing operational efficiency, player safety, and patron loyalty.

Each of the embodiments described herein are contemplated as falling within the inventive subject matter, which is set forth in the following claims.

1-8. (canceled)

9. An electronic system configured to provide player gaming trends and preference data, the system comprising:
a GPS-enabled portable electronic device having a mobile app therein;
a database on a processor configured to store:
gaming trends and preference data in players' profiles, the preference data sourced by player input; and,
gaming trends data received from a processor sensing usage of the mobile app and/or GPS;
wherein the data comprises products or services available from a gaming facility having a central processor configured to allow transmission of promotional offers to the players based on the players' profile when the players have approved access to their profile by the gaming facility, wherein the players' profiles include an indication of how the players desire to receive promotional offers;
the central gaming processor configured to detect the GPS-enabled PED of the players entering a defined GPS zone specific to the selected gaming facility utilizing a GPS feature of the PED.

10. The system of claim 9, the central gaming processor configured to allow the selected casino to provide a targeted discount offer, special offer, or gifting option to the player based on player analytics.

11-17. (canceled)

18. A method of providing funds to a player at a gaming facility comprising:
a portable electronic device sends a wireless communication to a funding establishment that supports a financial card;
the funding establishment supporting the financial card by storing an authorized level of credit available to the player from the financial card in memory;
the wireless communication containing data that identifies a) a specific financial card and a specific electronically-stored account established at the gaming facility on a server and b) an amount of funds to be applied against the financial card and transferred to the specific financial account;
the specific financial account receiving the transferred amount of funds and the gaming facility allowing electronic transfer of the transferred amount of funds; and
the specific financial account electronically transferring funds to a fund-providing electronic apparatus in the gaming facility.

19. The method of claim 18 wherein one or more processors at the gaming facility determine access information stored in a player profile, the access information to access the financial card account;
determining an amount to transfer from the financial card account to the specific financial account which is a casino cash account and then transfer a second amount to from the casino cash account to the fund-providing apparatus at the gaming facility.

20. The method of claim 19 wherein funds withdrawn from the fund-providing apparatus are transferred to an electronic video gaming apparatus.

21. A method comprising:
initiating, through a mobile app on a portable electronic device, an electronic funds transfer of a transaction amount from a financial credit card financial account to a casino-stored wagering establishment game account, wherein the credit card financial account has an established link to a wagering establishment-based player account;
the mobile app authorizing the financial card financial account through an encrypted transmission to transfer funds, the transfer of funds being debited against the financial card financial account into the wagering establishment-based player account;
funds transferred from the wagering establishment-based player account are transferred to a gaming apparatus selected from the group consisting of an electronic gaming machine, an electronic multiplayer gaming table, banked array of electronic games, electronic wagering input terminals and gaming tables; and
transferred funds in the gaming apparatus are placed at risk in a gaming event.

22. The method of claim 21 wherein the gaming apparatus comprises an electronic gaming machine.

23. The method of claim 22 wherein the financial card is a credit card assured by a financial institution.

24. The method of claim 23 wherein the financial institution is selected from the group consisting of banks, savings and loans and credit unions.

25. A system comprising:
a portable electronic device configured with an app to enable transactions to fund a wagering game account, the system including:
A) an electronic account manager configured to present a graphical user interface including menus for engaging a financial card transfer of funds through a pre-approved account relationship between:
a. a processor at a financial institute assuring the financial card; and
b. a processor configured to manage a specific player account at a wagering establishment, and
B) wherein the processor managing the specific player account is configured to transfer funds electronically to a gaming apparatus.

26. The method of claim 18 wherein the fund-providing apparatus consists of a cash providing system.

27. The method of claim 26 wherein the cash providing system is an automated teller machine.

28. The method of claim 26 wherein the cash providing system is a ticket-in-ticket-out apparatus at a casino.
